(19) United States
(12) Patent Application Publication
(10) Pub. No.: US 2006/0011380 A1
(43) Pub. Date: Jan. 19, 2006

(54) Cable tension management

(75) Inventor: James John Pierce, Irving, TX (US)

Correspondence Address: FISH & RICHARDSON PC, P.O. BOX 1022, MINNEAPOLIS, MN, 55440-1022, US

(73) Assignee: FMR, Corp., a Delaware corporation

(21) Appl. No.: 11/175,989

(22) Filed: Jul. 5, 2005

Related U.S. Application Data
(60) Provisional application No. 60/586,916, filed on Jul. 8, 2004.

(51) Int. Cl. H01B 7/00

(52) U.S. Cl. 174/135

(57) ABSTRACT

A cable tension management device that includes a substantially rigid substrate having a first end and a second end located opposite the first end, wherein the substrate is bent at an angle between the first and second end thereby defining a base portion and an angled portion of the substrate, and one or more fasteners for securing cable to a surface of the substrate. The cable tension management device may be secured to a supporting structure (e.g., a cable management rack) and receive cable connected to interconnection points above the cable tension management device such that it supports at least some of the weight of the cable.

### RELATED APPLICATIONS

This application claims priority to U.S. Application Ser. No. 60/586,916, filed Jul. 8, 2004, the content of which is incorporated herein by reference.

### TECHNICAL FIELD

This description relates to a cable tension management.

### BACKGROUND

Computer networks often include massive numbers of cables to interconnect devices on the network. Because network problems can be caused by loose connections, cable management racks, such as those manufactured by Chatsworth Products, Inc., are typically employed to house and manage a multitude of cable interconnect.

### SUMMARY

In one aspect, the invention features a cable management system that includes a cable management rack and a cable tension management device secured to the cable management rack. The cable tension management device includes a substantially rigid substrate configured to receive cable connected to the cable management rack such that at least a portion of the weight of the cable is supported by the cable tension management device.

In another aspect, the invention features a cable tension management device that includes a substantially rigid substrate having a first end and a second end located opposite the first end, wherein the substrate is bent at an angle between the first and second end thereby defining a base portion and an angled portion of the substrate and one or more fasteners for securing cable to a surface of the substrate. The cable tension management device may be secured to a supporting structure (e.g., a cable management rack) and receive cable connected to interconnection points above the cable tension management device such that it supports at least some of the weight of the cable.

In another aspect, a cable management device includes a substrate and a plurality of fasteners. The substrate has a far end that transitions at an angle away from the longitudinal axis of the substrate, thereby creating a base portion, and an angled portion. The fasteners are located on the base portion and angled portion of the substrate.

Other examples can include one or more of the following features. The angled portion of the substrate can transition away from the longitudinal axis of the substrate at an angle of between about 30 degrees and about 150 degrees. More particularly, the angled portion of the substrate can transition away from the longitudinal axis of the substrate at an angle of substantially 90 degrees. The angled portion of the substrate can transition through a radial bend in the substrate. The angled portion of the substrate can transition through a substantially angular bend in the substrate. The angled portion of the substrate can also transition through a series of substantially angular bends in the substrate.

The substrate may be dimensioned as to be slideably inserted through the cable conduit members of a cable management rack. The fasteners may be hook-and-loop, strap and buckle, or other types of releasable or non-releasable fasteners and may support cable along the base and/or angled portions of the substrate.

In another aspect, the invention features a method of relieving tension at cable interconnect points on a cable management rack that includes positioning a substantially rigid substrate beneath interconnection points on a cable management rack and securing cable connected to the interconnection points to the substrate such that at least a portion of the weight of the cable located above the substrate is supported by the substrate.

Embodiments can realize one or more of the following advantages. The cable tension management device provides tension relief at fiber cable interfaces, and, more particularly, provides tension relief on fiber cables at the fiber cable head (cable interconnect point) in a computer network, such as a storage area network (SAN). Cable tension fasteners are employed to secure cable bundles to the base portion and the angled portion of the cable tension management device. The angled portion of the substrate allows the cable to safely transition from an inclined position to a substantially horizontal position, thereby relieving tension from the cable and the termination point resulting in extended life and usability of the cables.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a perspective view of a cable tension management device.

FIG. 1B is a side view of another cable tension management device.

FIGS. 2-3 is a plan view and perspective view, respectively, of a cable tension management device mounted to a cable management rack.

FIG. 4 is a perspective view of another cable tension management device.

FIG. 5A-5C are side views of three cable tension management devices.

Like reference symbols in the various drawings indicate like elements.

### DETAILED DESCRIPTION

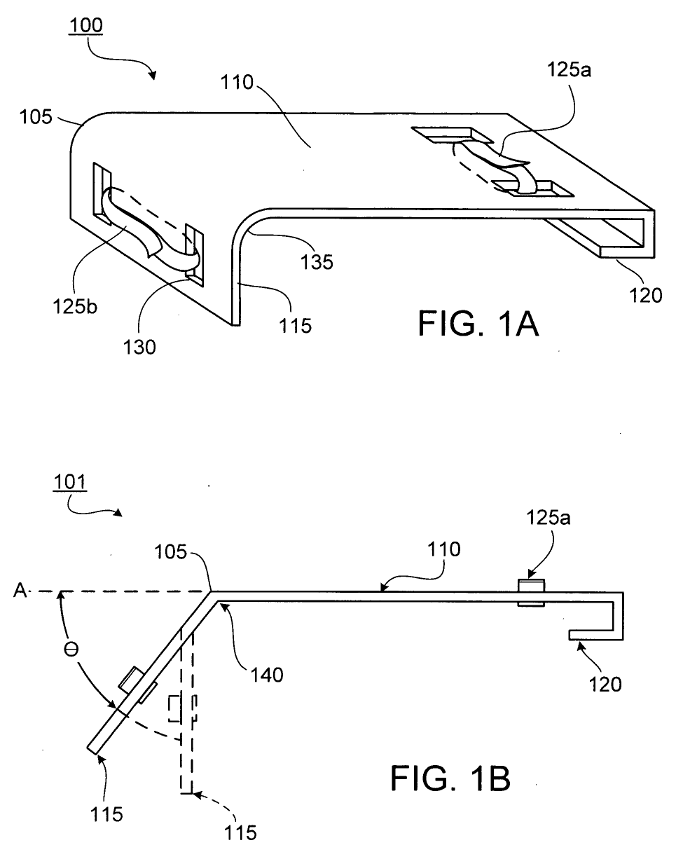

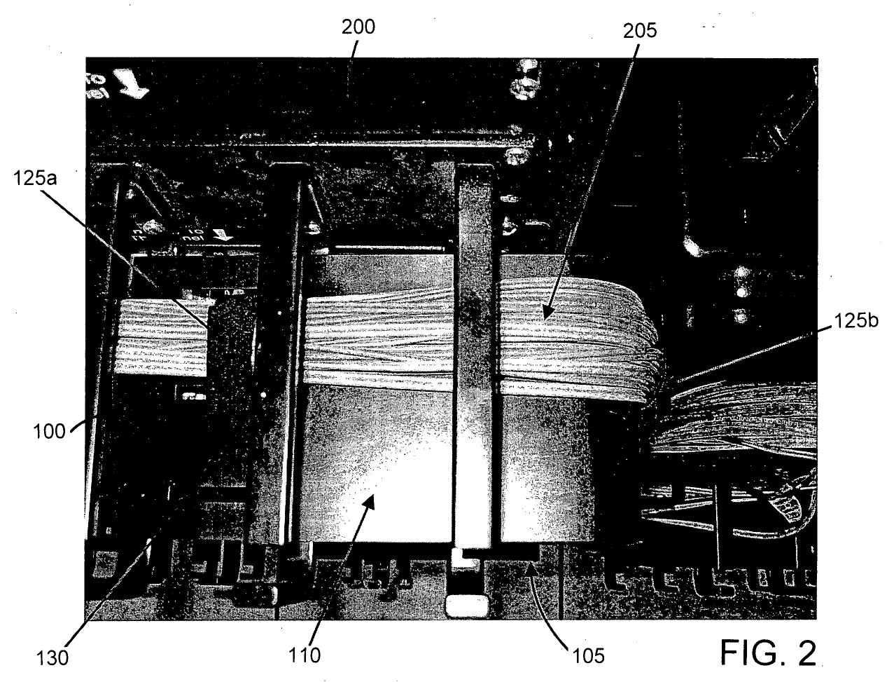

Referring to FIG. 1, a cable tension management device 100 includes a body 105 having a far end transitioning at an angle away from a longitudinal axis of the body, thereby creating a base portion 110 and an angled portion 115. In this particular implementation, the angled portion of the body transitions through a radial bend 135 in the body. The cable tension management device also includes a clip 120 located at an end of the body opposite the angled portion 115. As will be described in more detail below, the clip 120 provides a means for attaching the cable tension management device to a cable management rack. The cable tension management device also includes two fasteners 125a, 125b are attached, one of which (i.e., fastener 125a) is located on the base portion 110, and another one of which (i.e., fastener 125b) is located on the angled portion 115 of the body 105. The cable tension fasteners 125 are attached to the body 105 of the cable tension management device through a plurality of slotted openings 130.

As shown in FIG. 1b, another cable tension management device 101 has an angled portion 115 of its body 105 transitioning at an angle (θ) away from the longitudinal axis (A) of the body 105. FIG. 1b illustrates the angled portion 115 of the body 105 as transitioning through a sharp angular bend 140 in the body 105. As indicated by the dashed lines in FIG. 1b, the angled portion 115 can transition through a series of sharp angular bends in the body 105 to achieve the desired angle (θ).

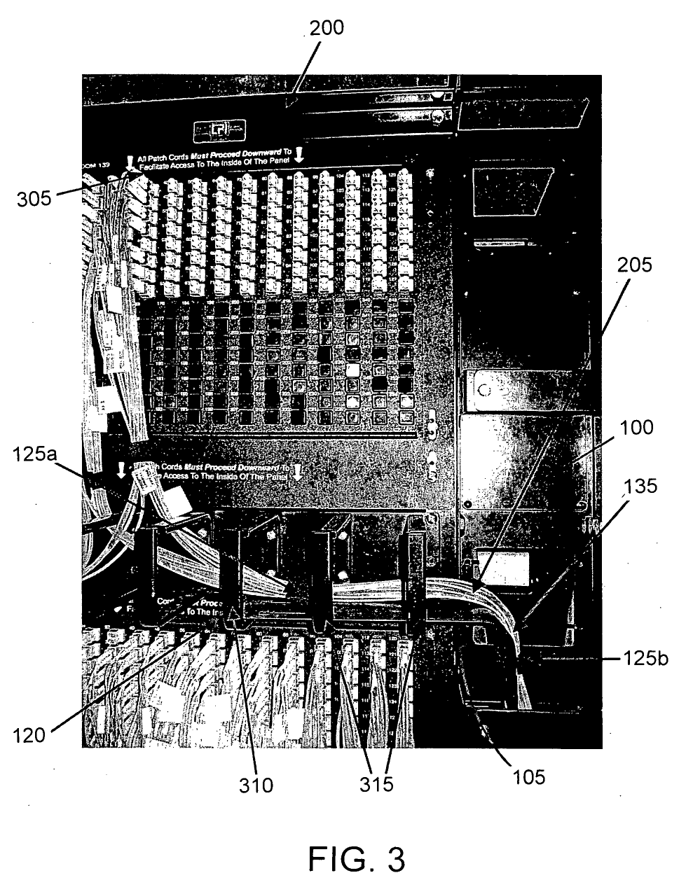

As shown in FIGS. 2-3, cable tension management device 100 is attached to a cable management rack 200 by clipping clip 120 to a cable conduit member 310 of the cable management rack. The width and length of the body 105 of the cable management device 100 is dimensioned such that it can be slideably inserted through the cable conduit members 310 and 315.

The cable tension management device 100 is located below several cable interconnection points 305 on the cable management rack and the cables 205 connected to these interconnection points are releasably secured to the body of the cable management device. In this implementation, cable is releasably secured to the cable management device in the horizontal direction by hook and loop fastener 125a, and in the vertical direction by hook-and-loop fastener 125b. By securing the cables 205 to body, the cable management device is supports the weight of the cables 205 and alleviates stress associated with gravitational forces at the cable interconnect points 305. The amount of stress relief offered is dependent on the proximity of the body 105 to the cable interconnect points 305. As the distance between the body 105 and the cable interconnect points 305 increases, the length of cable that is unsupported typically increases which reduces the amount of stress relief. Thus, it is typically preferably to locate the cable tension management device below and relatively close to the interconnection points 305 of the cable.

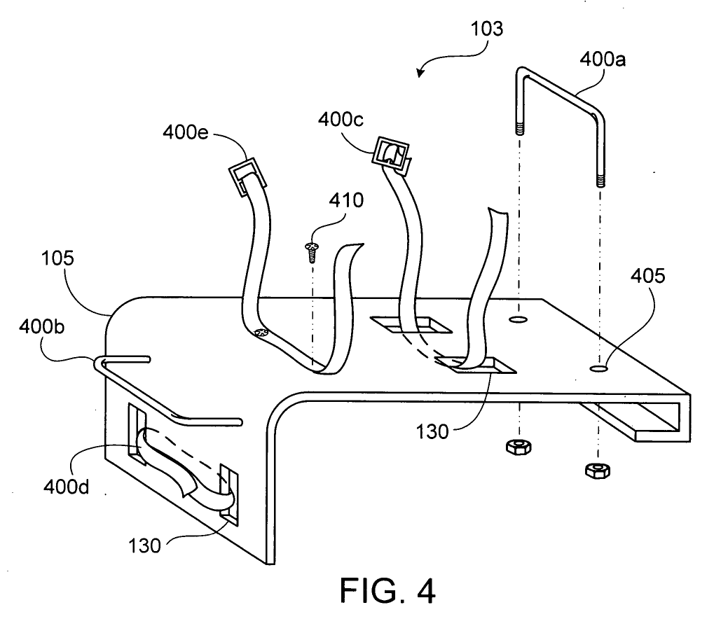

While the cable management device 100 shown in FIGS. 2-3 uses hook-and-loop fasteners to secure cable to the body, other implementations may use other types of fasteners—both relesable and non-releasable—to secure cable. For example, as shown in FIG. 4, a cable tension management device 103 includes a pair of U-bolt fasteners 400a-400b that are attached to the base portion 110 of the body 105 through holes 405. When cable is laid along the surface of the body, the U-bolt fasteners may be tightened to clamp the cable to the body. The cable management device 103 also includes three strap-and-buckle fasteners 400c-400e to secure cable to the cable management device in both the vertical and horizontal directions. Two of the strap-and-buckle fasteners 400c-400d are removably attached to by inserting them through slotted openings 130, while the third strap-and-buckle fastener 400e is permanently attached to the body with a pair of screws 410. Other embodiments may employ other releasable or non-releasable fasteners to secure cable to the body such as cable ties, clips, or clamps. In other implementations, the cable tension management device may include a groove along the longitudinal axis of its body in order to provide a channel in which the cable may lie.

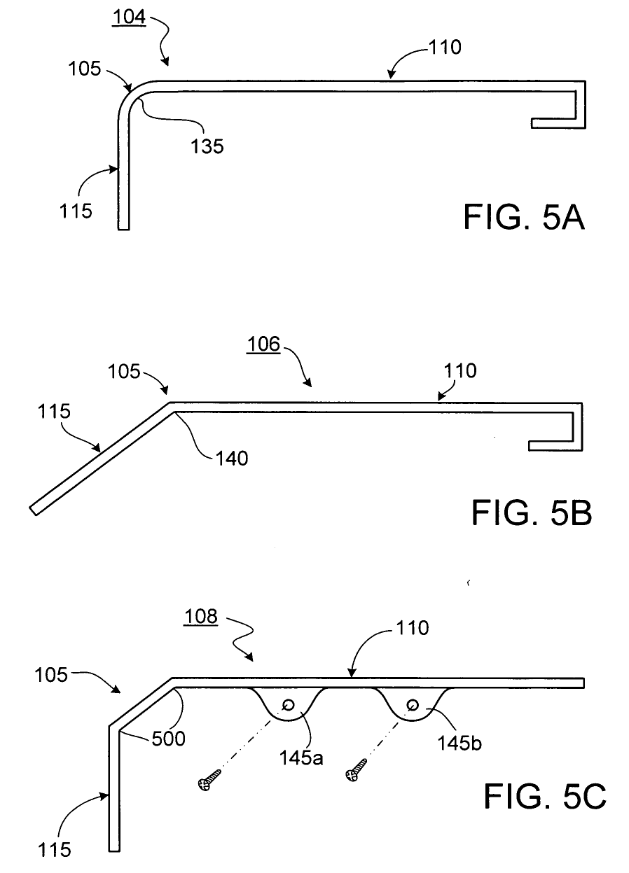

As shown in FIGS. 5a-5c, cable tension management devices 104, 106, 108 have differently contoured body portions. In FIG. 5a, cable management device 104 has a body 105 that transitions through a radial bend 135 that defines it base and angled portion. In FIG. 5b, cable tension management device 106 has a body with a sharp angular bend 140, whereas in FIG. 5c, cable tension management device 108 has a body with two sharp angular bends 500. Additionally, cable tension management device 108 shown in FIG. 5C includes two flanges 145a-145b projecting from the lower surface of the body 105 that provide a means for attaching the cable management device to a cable management rack by, e.g., screws inserted through holes 150a and 150b. Other implementations may permanently or releasably secure the cable tension management device to a cable management rack or other structure such as by bolting, welding, cementing, clamping, or clipping the cable tension management device to a support structure.

A number of embodiments of the invention have been described. Nevertheless, it will be understood that various modifications may be made without departing from the spirit and scope of the invention. For example only and not to limit other alternatives, the angled portion of the body can transition from the longitudinal axis of the body from between about 30 degrees and about 150 degrees. In some cases the angled portion of the body can transition at an angle of substantially 90 degrees away from the longitudinal axis of the body. The body of the cable tension management device is preferably formed of a rigid material that can support weight of cable such as plastic, metal, or a composite material. A cable tension management device may be formed by molding a hard plastic sheet or by stamping and forming sheet metal. The cable tension fasteners can be secured to the body in a number of different ways including by screwing, bolting, clipping, clamping, or cementing. Additionally, cable tension fasteners can be positioned in substantially parallel rows on the base and angled portions of the body. Separate cable bundles can be managed individually by providing parallel rows of cable tension fasteners and locating each bundle in its own fastener row. Additionally, while the cable tension management devices described above have a single-piece body, other embodiments may have a body formed of multiple pieces. For example, two flat strips of metal or other material may be welded together along one of each of their respective ends at an angle to form the body of a cable tension management device. Accordingly, other embodiments are within the scope of the following claims.

What is claimed is:

1. A cable tension management device comprising:
a substantially rigid substrate having a first end and a second end located opposite the first end, wherein the substrate is bent at an angle between the first and second end thereby defining a base portion and an angled portion of the substrate; and
one or more fasteners for securing cable to a surface of the substrate.

2. The cable tension management device of claim 1 wherein the one or more fasteners include releasable fasteners.

3. The cable tension management device of claim 1 wherein the base portion of the substrate is substantially planar.

4. The cable tension management device of claim 1 wherein the angled portion of the substrate is substantially planar.

5. The cable tension management device of claim 1 further including means for securing the cable tension management device to a supporting structure.

6. The cable tension management device of claim 5 wherein the securing means comprises a clip.

7. The cable tension management device of claim 1 wherein the fasteners are configured to secure cable in a generally horizontal direction.

8. The cable tension management device of claim 1 wherein the fasteners are configured to secure cable in a generally vertical direction.

9. A cable management system comprising:
a cable management rack that provides a plurality of cable interconnection terminals each adapted to receive a cable; and
a cable tension management device secured to the cable management rack and including substantially rigid substrate having a first end and a second end located opposite the first end, and having a bend between the first and second ends that defines a base portion and an angled portion of the substrate, wherein the cable management device is located below at least some of the interconnection terminals and is configured to receive cable connected to the interconnection terminals above the cable tension management device such that the weigh of the cable is supported by the cable tension management device.

10. The cable management system of claim 9 wherein the cable tension management device further includes one or more fasteners for securing cable to a surface of the substrate.

11. An apparatus comprising:
a body having a far end transitioning at an angle away from a longitudinal axis of the body, thereby creating a base portion, and an angled portion;
a plurality of cable tension fasteners located on the base portion and the angled portion of the body.

12. The apparatus according to claim 11 wherein the body is so dimensioned as to be slideably inserted through cable conduit members of a cable management rack.

13. The apparatus according to claim 11 wherein the angled portion of the body transitions at angle away from the longitudinal axis of the body from between about 30 degrees and about 150 degrees.

14. The apparatus according to claim 13 wherein the angled portion of the body transitions at an angle of substantially 90 degrees away from the longitudinal axis of the body.

15. The apparatus according to claim 11 wherein the angled portion of the body transitions through a radial bend in the body.

16. The apparatus according to claim 11 wherein the angled portion transitions through a substantially angular bend in the body.

17. The apparatus according to claim 11 wherein the angled portion transitions through a series of substantially angular bends in the body.

18. The apparatus of claim 11 wherein the body is molded from plastic.

19. The apparatus according to claim 11 wherein the body is formed from sheet metal.

20. The apparatus according to claim 11 wherein the body is configured to be secured to a cable management rack.

21. The apparatus according to claim 11 wherein the body further comprises a clip for securing the body to a cable management rack.

22. The apparatus according to claim 11 wherein the cable tension fasteners are hook-and-loop fasteners.

23. The apparatus according to claim 11 wherein the cables tension fasteners are positioned in substantially parallel rows on the base and angled portions of the body.

24. The apparatus according to claim 23 wherein a separate cable bundle is located within each row of the parallel rows of cable tension fasteners.

25. The apparatus according to claim 11 wherein the apparatus further comprises at least one cable located within one or more of the cable tension fasteners.

26. The apparatus according to claim 11 wherein the apparatus further comprises a cable management rack that includes a number of interconnection points, and wherein the body is located below at least some of the interconnection points and is adapted to receive cable connected to the interconnection points above the body such that at least some of the weight of the cable is supported by the body.

27. A method of relieving tension at cable interconnect points on a cable management rack, the method comprising:
positioning a substantially rigid substrate beneath interconnection points on a cable management rack;
securing cable connected to the interconnection points to the substrate such that at least a portion of the weight of the cable located above the substrate is supported by the substrate.

28. The method of claim 27 wherein the at least a portion of the substrate is positioned in a generally horizontal position.
